(19) United States
(12) Patent Application Publication
(10) Pub. No.: US 2013/0108780 A1
(43) Pub. Date: May 2, 2013

(54) METHOD OF MAKING A THIN FILM

(71) Applicants: Sudhir Ramprasad, Corvallis, OR (US); Daniel R. Palo, Philomath, OR (US)

(72) Inventors: Sudhir Ramprasad, Corvallis, OR (US); Daniel R. Palo, Philomath, OR (US)

(73) Assignee: BATTELLE MEMORIAL INSTITUTE, Richland, WA (US)

(21) Appl. No.: 13/287,628

(22) Filed: Nov. 2, 2011

(51) Int. Cl. B05D 1/40; B05D 3/00; B05D 5/00

(52) U.S. Cl. 427/108; 427/355

(57) ABSTRACT

A method of making a thin film is disclosed. A solution is dispensed on a substrate. The solution is spread into a thin layer with a hydrophilic material. The substrate or the hydrophilic material is moved relative to the other. In one embodiment, a thin film grows on the substrate by chemical reaction with the solution. In an alternative embodiment, the solution is evaporated, leaving behind a particulate film.

### STATEMENT REGARDING FEDERALLY SPONSORED RESEARCH OR DEVELOPMENT

The invention was made with Government support under Contract DE-AC-05-RL01830, awarded by the U.S. Department of Energy. The Government has certain rights in the invention.

### TECHNICAL FIELD

This invention relates to thin films. More specifically, this invention relates to a method of making a thin film on a substrate using a hydrophilic material.

### BACKGROUND OF THE INVENTION

Cadmium Sulfide (CdS) thin films are commonly used as heterojunction partners in cadmium telluride (CdTe) and copper indium gallium di-selenide (CIGS) thin-film solar cells. CdS is used to maximize the amount of light absorbed in the active area of the solar cells and minimize shunting.

In the US, the Department of Energy's SunShot Initiative has the goal to make solar energy technologies cost-competitive with other forms of electricity by reducing the cost for solar energy systems by 75% by the year 2020. Drastic changes in materials and/or processing to manufacture solar cells are required to fulfill this goal. Chopra et al, in Prog Photovoltaics, 2004, 12, 69-92, in their review on thin film solar cells have emphasized the necessity of low-cost manufacturing techniques for CdTe and CIGS thin film solar cells. Among the prevalent vacuum-based techniques, close-spaced sublimation (CSS) has been the industrially preferred choice for production of absorber (CdTe) layers in thin film solar cells. However, CSS utilizes very high substrate temperature >500° C. which necessitates expensive substrates that can withstand the high operating temperature and high-energy processing, contributing to the overall cost of the solar cell.

Several solution-based processes such as electro-deposition, screen printing, inkjet printing, and chemical bath deposition, have been reported for developing thin film solar cells (see, for example, Cunningham et al, Prog Photovoltaics 2002, 10, 159-168; Dharmadasa et al., J Electrochem Soc, 2010, 157, H647-H651; Suyama et al., IEEE Phot Spec Conf, 1990, 498-503; Klad'ko, Semiconductor Physics, Quantum Electronics & Optoelectronics, 2005, 8, 61-65; Chang et al., Sol Energ Mat Sol C, 2011, 95, 2616-2620; G. Hodes, Chemical solution deposition of semiconductor films, Marcel Dekker Inc, New York, 2003). Since these solution-based processes have not been able to economically scale-up, the current solar industry has relied entirely on vacuum based techniques for production, limiting these solution based processes entirely to research labs. Some coating techniques like slot-die coating, gravure coating, or doctor blading have been successfully implemented in other industrial applications, although none of these techniques have been reported for CdTe or CIGS manufacturing, to our knowledge.

Chemical bath deposition (CBD) is a widely investigated solution-based method for generating CdS films. The literature for CBD is almost entirely focused, on small substrate sizes (e.g., 25 mm×75 mm). Despite the scalability challenges in CBD, some research groups have attempted to scale-up using larger substrates. Archibold et al, in Thin Solid Films, 2007, 2007, 515, 2954-2957 and Dhere et al., in Sol Energy, 2004, 77, 697-703 have deposited CdS films on 100 mm×100 mm glass and metal foil substrates, respectively. The CBD process developed by these research groups suffers from low material utilization coupled with the large amount of waste generated, rendering it unattractive to large scale implementation.

In the case of screen printing it is challenging to produce films less than 10 μm, a full two orders of magnitude too high for solar PV-relevant CdS films (see Burgelman M., Thin Film Solar Cells by Screen Printing Technology, Lodz, 1998). In addition, there is a cost burden because of the substantial heat treatment required to produce high quality films. Doctor blading can only be used for solution chemistries that do not aggregate or crystallize at high concentration (see Krebs F. C., Sol Energ Mat Sol C, 2009, 93, 394-412). Spray pyrolysis has been frequently reported in the literature, however it necessitates higher deposition temperature (>400° C.). Spray nozzles have requirements of certain minimum pressure, certain minimum flow rate to generate an even flow distribution, and often necessitate maintenance to avoid plugging of nozzles when employed for applications with reactive chemicals.

In order for solution deposition to be adapted as a viable technology for large scale manufacturing, it is critical to develop deposition techniques that can be easily transitioned to continuous mode. The success of integrating continuous solution deposition into industrial scale production is largely dependent on the choice of coating technique. There is a need in thin film coatings for simple and cost effective processes that can be used in non-ideal environments and involving aggressive chemicals, high temperature, and challenging reaction chemistries. The requirement is to quickly and evenly provide contact of a thin layer of aqueous, reactive solution with a hydrophilic glass substrate without the long upstream hold-up time characteristic of doctor blade or slot coating approaches. These long hold-up times will cause the solution to age, leading to undesirable precipitation reactions. The reaction mixture for CdS production is time sensitive, homogeneously forming undesired particles that will aggregate, cause equipment fouling, and reduce overall material yield.

### SUMMARY OF THE INVENTION

The present invention is directed to a method of making a thin film. The method comprises dispensing a solution on a substrate; spreading the solution with a hydrophilic material; and moving one of the substrate and the hydrophilic material relative to the other.

In one embodiment of the present invention, a polycrystalline thin film grows on the substrate by chemical reaction with the solution. In an alternative embodiment, a slurry solution is evaporated, leaving behind a particulate film. In an alternative embodiment, a particulate thin film grows on the substrate by chemical reaction with the solution.

In one embodiment of the present invention, the solution comprises a polar liquid stream. The solution is reactive or a slurry. The solution can comprise reactants for producing a cadmium sulfide (CdS) film.

In one embodiment of the present invention, the substrate comprises a transparent conducting oxide (TCO) layer. The TCO layer comprises fluorine-doped tin oxide (FTO), indium-doped tin oxide (ITO), or other appropriate TCO material.

In one embodiment of the present invention, the hydrophilic material comprises a ceramic rod. The ceramic rod can be made of alumina, zirconia, any oxide ceramic, non-oxide ceramics, or combinations thereof. The diameter of the rod is between 1 and 26 mm and the length of the rod is between 5 and 660 mm.

In one embodiment of the present invention, the hydrophilic material is suspended above the substrate. A gap between the substrate and the hydrophilic material is sufficient to maintain a liquid meniscus between the hydrophilic material and the substrate. The length of the hydrophilic material is longer than the width of the substrate.

In one embodiment of the present invention, the spreading includes a lateral wicking action to uniformly coat the substrate in the lateral dimension as the rod moves in the axial direction relative to the substrate. The substrate has a width in the range of 10 mm to 610 mm and a length of at least 10 mm. The substrate is made of glass, metal, plastic, ceramic, a semiconductor, or combinations thereof.

In one embodiment of the present invention, the method further comprises continuous liquid dispensing on the substrate. The continuous liquid dispensing can be intermittently paused and resumed. The method also comprises pre-heating of the liquid, the substrate, or both.

In one embodiment of the present invention, the substrate is of substantially the same polarity as the hydrophilic material and the solution. The solution is removed by pulling the solution through the substrate or by evaporation or by physical (e.g., vacuum) removal or by rinsing or by any combination thereof.

In one embodiment of the present invention, the substrate is coated by a thin film prior to the dispensing. In one embodiment, a dwell time of the solution on the substrate is varied in order to control a final thickness of the film.

In another embodiment of the present invention, a method of making a thin film is disclosed. The method comprises dispensing a polar solution on a substrate and spreading the solution uniformly on the substrate with a ceramic rod. The method, also comprises moving one of the substrate and the rod relative to the other in one direction forwards and backwards, wherein the substrate is of substantially the same polarity as the rod and the solution.

In another embodiment of the present invention, a method of making a thin film is disclosed. The method comprises dispensing a cadmium sulfide-producing solution on a glass substrate and spreading the solution across the width of the substrate with a ceramic rod to uniformly coat the substrate. The method also comprises moving one of the substrate and the rod relative to the other in one direction forwards and backwards. The method further comprises continuous dispensing of the solution on the substrate, wherein the substrate is of substantially the same polarity as the rod and the solution.

### BRIEF DESCRIPTION OF THE DRAWINGS

FIG. 1A is an illustration for making a thin film that shows a solution dispensed on a substrate before coming in contact with a hydrophilic material, in accordance with one embodiment of the present invention.

FIG. 1B is an illustration for making a thin film that shows the solution stretching into a thin layer after contacting the hydrophilic material, in accordance with one embodiment of the present invention.

FIGS. 2A-2C show a pilot unit for making a thin film in process sequence as the substrate travels on a heated boat from left to right through (A) substrate preheat, (B) liquid solution deposition, and (B) rinse.

FIG. 3 shows a picture of CdS film deposited by means of the present invention on 152 mm×152 mm (6 in×6 in) FTO glass substrate (scale bars are in inches).

FIG. 4 shows the grazing-incidence X-ray diffraction patterns of a typical CdS film deposited by the present invention on a FTO coated glass substrate.

FIG. 5 shows a plot of absorption coefficient vs. band gap for a CdS film produced by means of the present invention.

FIG. 6 is a summary of CdS film thickness and uniformity for the various experimental conditions tested, including an entire 152-mm substrate and 102-mm central portion.

### DETAILED DESCRIPTION OF THE PREFERRED EMBODIMENTS

The present invention includes several embodiments to produce consistent and repeatable thin films. Firstly, a thin film-generating solution is produced using a micro-mixer and a microchannel heat exchanger. Secondly, a liquid coating technique employs a hydrophilic material, such as a ceramic rod, to efficiently and uniformly apply reactive solution to large substrates (e.g., 152 mm×152 mm). Thirdly, a scalable pilot deposition unit is disclosed that shows a pathway to larger scale manufacturing. CdS thin films were generated using, as one example, an industrially relevant substrate—float glass coated with fluorine-doped tin oxide.

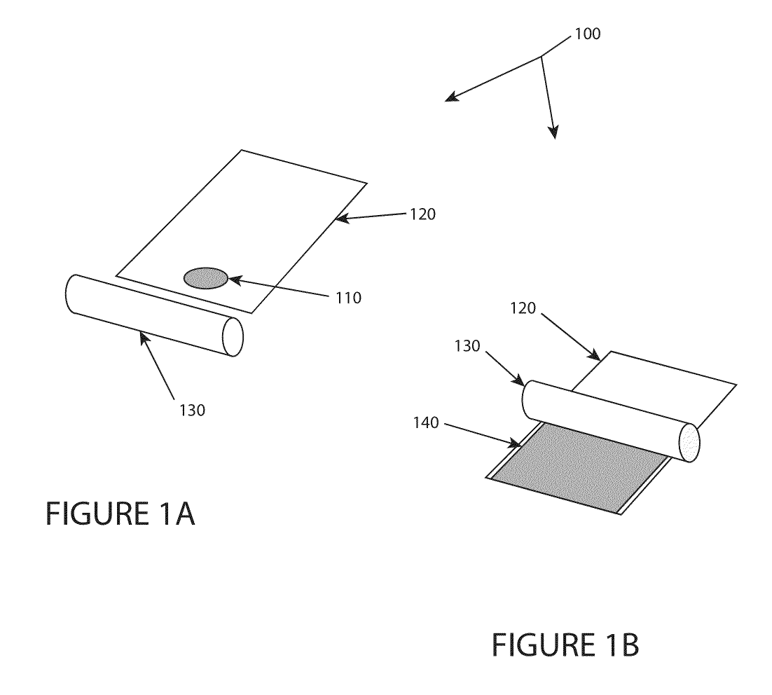

FIG. 1A is an illustration for making a thin film that shows a solution 110 dispensed on a substrate 120 before coming in contact with a hydrophilic material 130, in accordance with one embodiment of the present invention. FIG. 1B is an illustration for making a thin film that shows the solution stretching into a thin layer 140 after contacting the hydrophilic material 130, in accordance with one embodiment of the present invention.

In one embodiment, as the substrate 120 is wetted by the solution 110, the substrate 120 moves under or relative to the hydrophilic material 130, leaving a thin layer 140 of solution 110. In this embodiment, the substrate 120 is initially wetted as a puddle in a small region of the substrate 120, and the hydrophilic material 130 wicks the solution 110 across the entire width of the substrate 120. As the substrate 120 moves, the entire substrate 120 is wetted, and the puddle becomes a thin layer.

In an alternative embodiment, after the substrate 120 is wetted by the solution, the hydrophilic material 130 moves relative to the substrate 120, leaving a thin layer 140 of solution 110. In one embodiment, the solution 110 comprises a polar liquid stream. The solution 110 can be reactive or a slurry.

In one embodiment, the hydrophilic material 130 is suspended above the substrate 120 by a very small distance. The small distance between the hydrophilic material 130 and the substrate 120 and the hydrophilic nature of the material 130 creates a capillary effect that draws the solution 110 across the width of the substrate 120, fully wetting the substrate 120.

Still referring to FIGS. 1A and 1B, a polycrystalline thin layer or a particulate thin layer can grow on the substrate 120 by chemical reaction with the solution 110. When the solution is a slurry, a particulate thin layer is left behind when the solution 110 is evaporated.

In one embodiment, the hydrophilic material comprises a ceramic rod made of aluminum oxide, which is hydrophilic and assists in spreading the solution into a thin liquid layer on the substrate. The ceramic rod can be used in aggressive chemical environments and at a high temperature (e.g., up to 500° C.). This application of the rod can potentially be used in developing thin films for photovoltaic applications.

The diameter of the ceramic rod is between about 1 and 26 mm and the length of the rod is between about 5 and 660 mm, in one embodiment. The ceramic can comprise alumina, zirconia, any oxide ceramic, non-oxide ceramics, or combinations thereof.

The present invention, in one embodiment, uses wicking action to spread the solution across the substrate. This is due to the hydrophilic nature of the rod and the small gap between the rod and the substrate. Once wetted, this rod-gap combination causes the solution to quickly wick across the width of the substrate, creating a thin liquid layer on the substrate. This is accomplished without the need for liquid hold-up—on the upstream side of the gap—or high pressures that would be required for a spray coating approach. Also, the gap between the substrate and the hydrophilic material (or rod) should be such that it is sufficient to maintain a liquid meniscus between the hydrophilic material and the substrate. In one embodiment, a lateral wicking action uniformly coats the substrate in the lateral dimension as the rod moves in the axial directions across the substrate. In one embodiment, the rod is stationary. In an alternative embodiment, the rod is rotating or moving.

In one embodiment, the substrate comprises a transparent conducting oxide (TCO) layer. The TCO layer can comprise fluorine-doped tin oxide (FTO), indium-doped tin oxide (ITO), or other appropriate TCO material. The substrate, in one embodiment, has a width in the range of about 10 mm to about 610 mm and a length of at least 10 mm. In one embodiment, the length of the hydrophilic material is longer than the width of the substrate.

This invention is further illustrated by the following examples that should not be construed as limiting

### EXPERIMENTAL SECTION

### Materials

Positive displacement pumps (Acuflow Series III) were used to pump each stream of reagents at a constant flow rate. All chemical reagents used were of ACS grade (>99% purity). Cadmium chloride provided the cadmium source, and thiourea provided the sulfur source. Stream A consisted of cadmium chloride (0.004 M), ammonium chloride (0.04 M), and ammonium hydroxide (0.04 M) in water. Stream B consisted of thiourea (0.08 M) in water. Special care should be taken in the handling of cadmium-containing solutions, including personal protective equipment, adequate ventilation, and proper disposal of waste.

The reagent reservoirs were placed on analytical balances (Ohaus) and the changes in the mass were recorded throughout the duration of the test. The reagents from the two streams were mixed in a T-mixer (Idex, Inc.) before entering the heat exchanger. Thermocouples at the inlet and outlet of the heat exchanger recorded the temperature of the fluid. Commercial soda lime glass (Pilkington TEC-15) with a transparent conducting oxide (TCO) layer was employed as the substrate for film deposition. The TCO layer consisted of fluorine-doped tin oxide (FTO). A Lab View (National Instruments) program was developed for data acquisition and control of temperatures, flow, and substrate positioning over time.

### Pilot Deposition Unit—Process Sequence

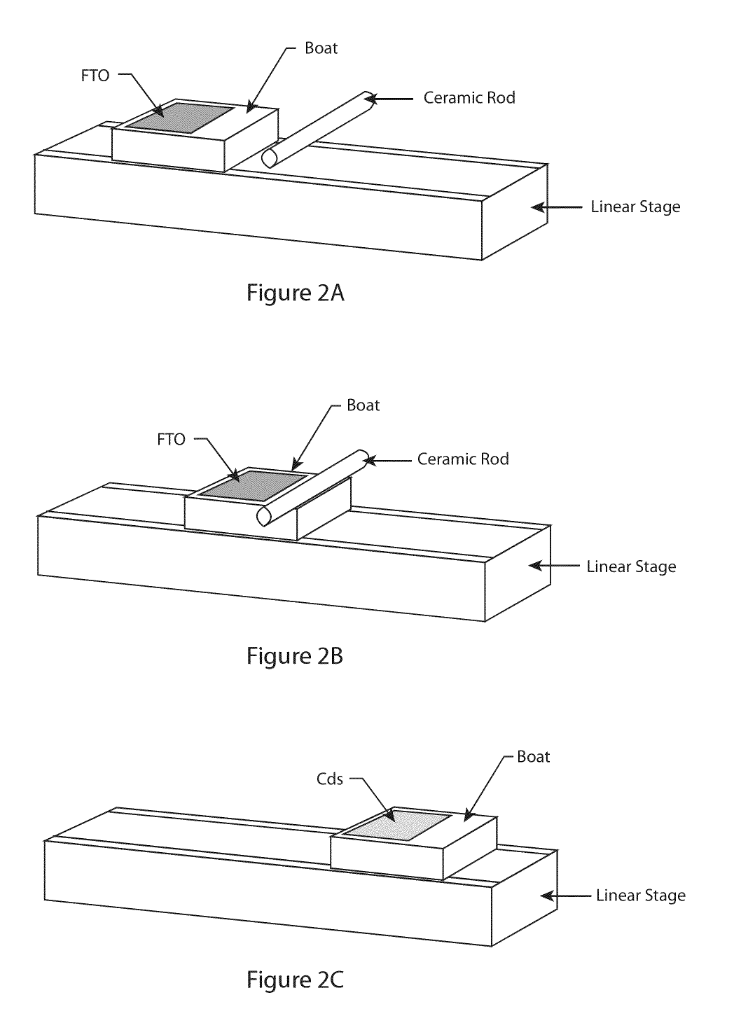

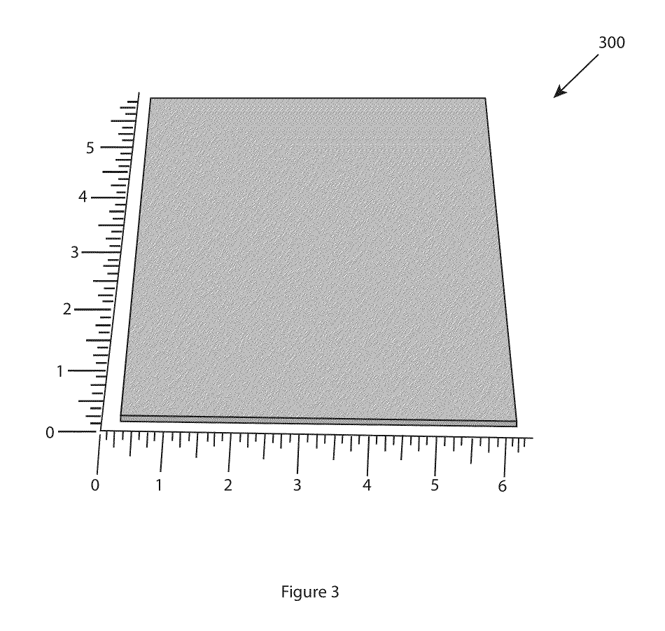

The pilot unit for CdS deposition consists of the process sequence described below and shown in FIGS. 2A, 2B and 2C. The steps of substrate preheating, fluid deposition, dwell time, and rinsing were employed in series.

### Preheating

The CdS reagents were heated to the desired solution temperature of ˜90° C. using the microchannel heat exchanger described previously. A linear stage (Techno, Inc) equipped with a platform and location controller was employed for moving the substrate between process sequences. A custom-designed boat intended for substrate heating and excess reactant solution collection was fixed to the platform. The boat housed a silicone heating pad (203 mm×203 mm, 10 W/in2, Omega) which was sandwiched between two metal plates. The cleaned substrate was then placed on the metal plate, where it received heat transferred from the silicone heating pad. The silicone pad was controlled manually by a variable voltage source. Four ceramic infrared heaters (152 mm×51 mm, Tempco, Inc., 425 W each) were mounted above the travel path to maintain a constant substrate temperature during transit. A programmable controller (Phoenix, Inc.) was used to precisely control the speed and position of the stage on the linear slide. A previously optimized program for the linear slide was chosen depending on the feed flow rate and the deposition time used for a specific test.

### Reagents Dispensing

A drip and spread mechanism as shown in FIGS. 1A and 1B was used for evenly coating the glass with reactive solution to grow uniform CdS films. Upon dripping the pre-heated CdS reagents on the pre-heated FTO coated glass substrate, a ceramic rod (Superior Technical Ceramics, ˜5 mm diameter and ˜230 mm long) was utilized to spread the droplets of reactant solution into a thin layer. The ceramic rod was composed of hydrophilic alumina, which assisted in spreading the liquid in to a thin layer on the hydrophilic FTO surface. A prescribed gap between the ceramic rod and the glass provided lateral wicking action to uniformly coat the substrate as the rod moved in the axial direction across the substrate. A secondary result of the rod movement is to siphon off excess reagents. The combination of rod and glass hydrophilicity, and the size of the gap between the two were crucial in providing adequate wicking action to spread the fluid across the entire substrate width.

### Dwell Time

Once coated with reactant solution, the substrate was held at constant temperature (usually the same temperature as for deposition) while the CdS film grew from the reagents in the liquid. Multiple passes of dispensing and dwell time were required to avoid substrate dry-out and achieve the required thickness of CdS film.

### Rinsing

At the end of each experiment, the CdS film deposited on the glass substrate was rinsed with DI water. A uniform, continuous, and particle-free CdS film was thus obtained.

### CdS Film Generation in the Pilot Deposition Unit

A typical deposition involved the following steps. A constant solution residence time of 15 seconds was used in the heat exchanger for all experiments. The 15-second residence time was chosen based on our previous parametric study (see Ramprasad et al., Solar Energy Materials & Solar Cells, 2011). The heat exchanger was pre-heated while circulating water, and the FTO glass substrate was simultaneously heated to deposition temperature (˜90° C.). The program for the linear slide was then activated, upon which the substrate was positioned exactly below the outlet of the heat exchanger. At the appropriate time, valves were switched from water to reagents for the pumps to begin feeding reagent mixtures A and B. The two reagent streams then flowed through the micro-mixer and entered the heat exchanger. The mixed fluid entering the heat exchanger assembly was rapidly heated to the reaction temperature in approximately one second, followed by the additional 14-second residence time period. Upon exiting the heat exchanger, the CdS reagent solution was distributed on the edge of the glass substrate, forming an initial puddle. The linear slide then traveled, at an optimized speed, bringing the heated substrate under the rod and spreading the reactant fluid into a thin layer on the surface of the FTO glass. The CdS reagents that continuously dripped on the FTO glass substrate were spread into a thin film by the ceramic rod while the linear slide moved back and forth to cover the entire area of the glass for the specified time. Depending on the dwell time the linear slide traveled multiple passes during the entire run. The CdS film formed on the substrate was rinsed with DI water to remove any particulates and by-products. The films produced were analyzed as-deposited, without any post-annealing.

### Characterization of CdS Film

The combination of inherently rough substrate, large sample area, and the need for rapid, non-destructive characterization of many samples required that we utilize a high-throughput thickness characterization method. Thin film thickness characterization techniques such as profilometry, SEM, ellipsometry, and AFM are inadequate to this task due to various limitations in throughput or performance with this film/substrate system. As a result, we developed a rapid, repeatable, and non-destructive thickness measurement technique based on UV-vis spectroscopy (Ocean Optics USB2000). Transmittance and reflectance were recorded at a constant wavelength of 500 nm at 36 different positions on each 152-mm sample. The UV-vis spectroscopy technique was calibrated to TEM-validated calibration samples, as described (see S. Ramprasad, et al., Cadmium sulfide thin film deposition: A parametric study using microreactor-assisted chemical solution deposition, Sol. Energy Mater. Sol. Cells (2011), doi:10.1016/j.solmat.2011.09.015).

The optical bandgap (Eg) was determined from the formula,

(ahv)^{1/n}=A(hv−E_{g})

where hv is the incident photon energy, A is a constant and the exponent “n” is an index value used to describe the direct band gap (n=½).

For morphological and structural characterization, the original 152-mm CdS/FTO sample was diced into 25.4-mm coupons. Focused-ion-beam milling (FIB) (FEI Quanta 3D SEM/FIB) was used for sample preparation for cross-sectional characterization by TEM (Philips CM-12). Carbon and platinum layers were deposited, on top of the CdS layer to reduce surface charge accumulation and to introduce a surface protection layer during the FIB milling process. AFM (Innova Scanning Probe Microscope, Bruker) was used for roughness measurement of the CdS films. A sample size of 25.4 mm×12.7 mm was used for AFM measurements. AFM analysis was performed by tapping mode on a scan area of 1.5 μm×1.5 μm. The crystalline structure was studied using grazing-incidence X-ray diffraction (Bruker, D8 Discover). All measurements were performed at room temperature for various CdS film thicknesses obtained at different deposition times. A Cu-Ka (λ=1.54 Å) radiation with an incident angle of 0.5° was used for all scans.

### Experimental Results and Discussion

### Process Characteristics

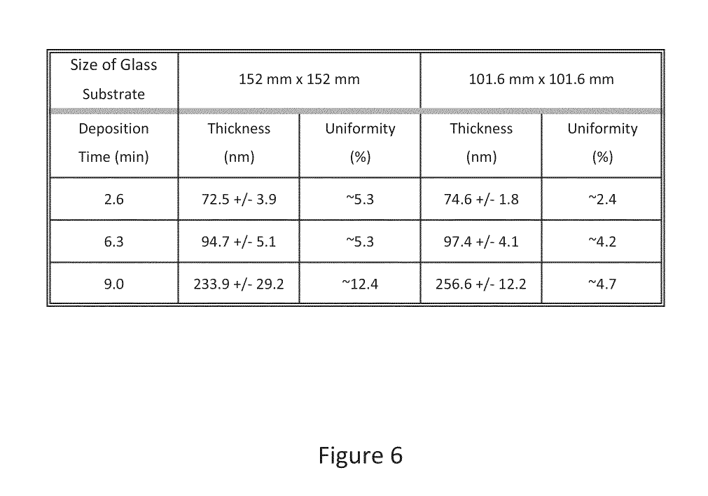

After glass pre-cleaning and system start-up, the 152-mm substrates were coated with a thin film of CdS having thickness ranging from 72 nm to 234 nm using process times of 2.6 min to 9.0 min, as listed in FIG. 6. The entire surface of the glass was coated with CdS to the desired thickness with excellent uniformity and continuity. Although the coating was conducted one substrate at a time, the developed system demonstrates the fundamental production-level operations required for a continuous, conveyorized production line. One of the significant features of this process is that any thickness can be easily obtained with sufficient deposition time.

### Thickness Uniformity

The film thickness average and standard deviation for each tested condition is summarized in FIG. 6. Three deposition times were explored, and the results reported represent the average of three replicates at the same condition. The thickness of the CdS film sample was developed, at a 2.6-min deposition time on a 152-mm FTO glass substrate, as recreated from 36 data points measured on the surface.

The 2.6-min deposition exhibits an average thickness of 72.5±3.9 nm, or a 5.4% thickness deviation over the entire surface. For the 102-mm central area, the average thickness is 74.6±1.8 nm, representing a 2.4% thickness deviation. Similar thickness uniformity results were observed for higher deposition times tested—deposition times of 6.3 min and 9.0 min, respectively. It can be observed from FIG. 6 that CdS films with thickness varying from 72 nm to 230 nm can be easily, rapidly, and continuously produced by varying the deposition time and with excellent uniformity.

### Structural Properties

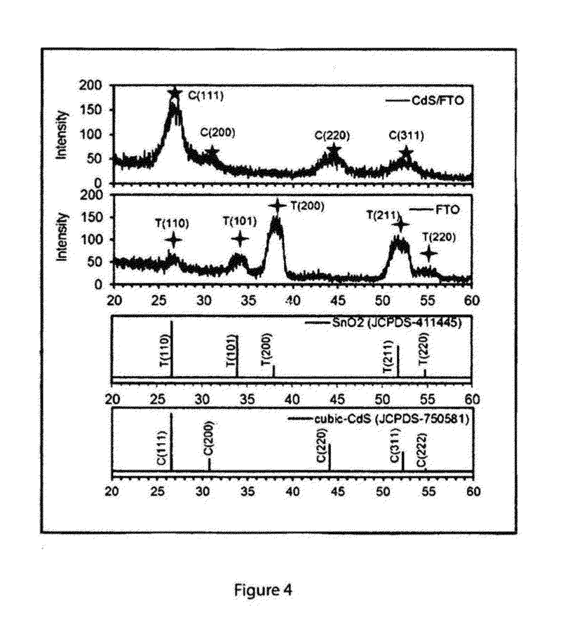

The grazing-incidence X-ray diffraction pattern of a typical CdS film deposited by MASD on FTO coated glass substrate is shown in FIG. 4. The as-deposited CdS film exhibits diffraction patterns typical of standard CdS (JCPDS-75081) with a preferred orientation of a cubic crystalline. It can also be observed that the diffraction pattern of the FTO matches closely with the standard (JCPDS-411445), as expected.

### Optical Properties

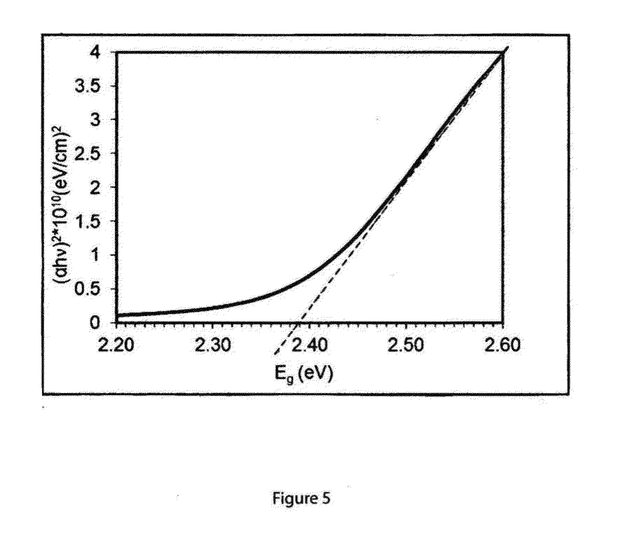

The plot of square of absorption coefficient vs. band gap is shown in FIG. 5. A sample CdS film with ˜100 nm thickness was used for estimating optical band gap, found at the intersection of the linear portion of the curve with the x-axis (0.0 eV/cm2). The band gap estimated for the MASD-produced CdS is ˜2.39 eV and is consistent with the values reported in the literature.

### Morphology

AFM analysis indicates that the root mean square surface (RMS) roughness of the CdS films is ˜11.3 nm, with an average roughness of ˜9.0 nm for films of roughly 95 nm thickness. The bare FTO glass exhibited a RMS value of ˜8.2 nm. Clearly, most of the roughness of the film is due to the underlying crystalline FTO surface. The TEM cross-sectional image of the CdS/FTO sample clearly showed the CdS conformally coated on the undulating pattern of the underlying FTO. Previously reported high-resolution TEM of our CdS/FTO films showed the CdS to be nano-crystalline and conformally coated to the crystalline FTO layer.

### Experimental Conclusions

A pilot deposition unit has been developed for CdS deposition on a FTO coated glass substrate (152 mm×152 mm) using the continuous microreactor-assisted solution deposition process. A novel coating technique that uses a ceramic rod in pilot deposition has demonstrated reproducible CdS films of excellent uniformity. The thickness of the CdS films developed varies from 70 nm to 230 nm, depending on deposition parameters used, and with 5-12% thickness variation. Morphological, structural, and optical characterization has indicated that the CdS films developed exhibit the properties necessary to be integrated in a thin film solar cell.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A method of making a thin film comprising:
a. dispensing a solution on a substrate;
b. spreading the solution with a hydrophilic material; and
c. moving one of the substrate and the hydrophilic material relative to the other.

2. The method of claim 1 wherein the solution comprises a polar liquid stream.

3. The method of claim 1 wherein the solution is reactive or a slurry.

4. The method of claim 3 wherein a polycrystalline thin film grows on the substrate by chemical reaction with the solution.

5. The method of claim 3 wherein the slurry solution is evaporated, leaving behind a particulate film.

6. The method of claim 3 wherein a particulate thin film grows on the substrate by chemical reaction with the solution.

7. The method of claim 1 wherein the substrate comprises a transparent conducting oxide (TCO) layer.

8. The method of claim 7 wherein the TCO layer comprises fluorine-doped tin oxide (FTO).

9. The method of claim 1 wherein the hydrophilic material comprises a ceramic rod.

10. The method of claim 9 wherein the ceramic comprises alumina, zirconia, any oxide ceramic, non-oxide ceramics, or combinations thereof.

11. The method of claim 9 wherein the diameter of the rod is between 1 and 26 mm.

12. The method of claim 1 wherein the hydrophilic material is suspended above the substrate.

13. The method of claim 12 wherein a gap between the substrate and the hydrophilic material is sufficient to maintain a liquid, meniscus between the hydrophilic material and the substrate.

14. The method of claim 1 wherein the spreading includes a lateral wicking action to uniformly coat the substrate in the lateral dimension as the rod moves in the axial direction across the substrate.

15. The method of claim 1 wherein the substrate has a width in the range of 10 mm to 610 mm and a length of at least 10 mm.

16. The method of claim 1 wherein the length of the hydrophilic material is longer than the width of the substrate.

17. The method of claim 1 further comprising continuous liquid dispensing on the substrate.

18. The method of claim 17 further comprising pre-heating of at least one of the liquid and the substrate.

19. The method of claim 1 wherein the substrate is of substantially the same polarity as the hydrophilic material and the solution.

20. The method of claim 1 wherein the substrate comprises one or more of glass, metal, plastic, ceramic, and semiconductor material.

21. The method of claim 1 wherein the solution is removed by pulling the solution through the substrate.

22. The method of claim 1 wherein the solution is removed by evaporation.

23. The method of claim 1 wherein the substrate is coated by a thin film prior to the dispensing.

24. The method of claim 1 wherein a dwell time of the solution on the substrate is varied in order to control a final thickness of the film.

25. The method of claim 1 wherein the solution comprises reactants for producing a cadmium sulfide (CdS) film.

26. The method of claim 17 wherein the continuous liquid dispensing is intermittently paused and resumed.

27. The method of claim 1 wherein the hydrophilic material is rotating.

28. A method of making a thin film comprising:
a. dispensing a polar solution on a substrate;
b. spreading the solution uniformly on the substrate with a ceramic rod; and
c. moving one of the substrate and. the rod. relative to the other in one direction forwards and backwards, wherein the substrate is of substantially the same polarity as the rod and the solution.

29. The method of claim 28 wherein the solution comprises a polar liquid stream.

30. The method of claim 28 wherein the solution is reactive or a slurry.

31. The method of claim 30 wherein the polycrystalline thin film grows on the substrate by chemical reaction with the solution.

32. The method of claim 30 wherein the slurry solution is evaporated, leaving behind a particulate film.

33. The method of claim 28 wherein the diameter of the rod is between 1 and 26 mm.

34. The method of claim 28 wherein the rod is suspended above the substrate.

35. The method of claim 34 wherein a gap between the substrate and the ceramic rod is sufficient to maintain a liquid meniscus between the ceramic rod and the substrate.

36. The method of claim 28 wherein the spreading includes a lateral wicking action to uniformly coat the substrate in the lateral dimension as the rod moves in the axial direction across the substrate.

37. The method of claim 28 wherein the substrate has a width in the range of 10 mm to 610 mm and a length of at least 10 mm.

38. The method of claim 28 wherein the length of the hydrophilic material is longer than the width of the substrate.

39. The method of claim 28 further comprising continuous liquid dispensing on the substrate.

40. The method of claim 39 further comprising pre-heating of at least one of the liquid and the substrate.

41. The method of claim 28 wherein the solution is removed by pulling the solution through the porous substrate or by evaporation.

42. The method of claim 28 wherein the substrate is coated by a thin film prior to the depositing.

43. The method of claim 28 wherein a dwell time of the solution on the substrate is varied in order to control a final thickness of the film.

44. A method of making a thin film comprising:
a. dispensing a cadmium sulfide-producing solution on a glass substrate;
b. spreading the solution across the width of the substrate with a ceramic rod to uniformly coat the substrate;
c. moving one of the substrate and the rod relative to the other in one direction forwards and backwards; and
d. continuous dispensing of the solution on the substrate, wherein the substrate is of substantially the same polarity as the rod and the solution.
